(19) United States
(12) Patent Application Publication
(10) Pub. No.: US 2026/0289578 A1
(43) Pub. Date: Sep. 24, 2026

(54) GENERATIVE AI SYSTEMS AND METHODS FOR SPECIFYING AND MONITORING COMPLIANCE PROTOCOLS

(71) Applicant: SBY GRC TECH LTD., Netanya (IL)

(72) Inventor: Benny Katz, Netanya (IL)

(73) Assignee: SBY GRC TECH LTD., Netanya (IL)

(21) Appl. No.: 19/085,222

(22) Filed: Mar. 20, 2025

(51) Int. Cl. G06Q 30/018; G06F 16/951; G06Q 10/0631

(52) U.S. Cl. CPC G06Q 30/018; G06F 16/951; G06Q 10/063112; G06Q 10/06316

(57) ABSTRACT

Embodiments of the present disclosure include a system and method for generating and managing compliance protocols tailored to organizational needs. A compliance schema may be generated by aggregating data from sources such as regulatory databases, industry standards, and organizational records using an Intelligent Data Collection (IDC) Module. The compliance schema may be processed by a Guided Execution Module (GEM) Engine, which prioritizes actionable data, identifies dependencies between compliance tasks, and sequences tasks into structured workflows. Embodiments may further include a Personalized Task Distribution System for creating and delivering role-specific workflows and updating employee records. The system may also feature a Modular Education, Reporting, and Evaluation System for administering training, tracking task adherence, and generating compliance performance data. Additionally, an Automated Standards Management and Monitoring System may ensure real-time adaptability to regulatory changes, while a Reporting Tool provides visualized metrics and predictive analytics to streamline compliance management.

### CROSS-REFERENCE TO RELATED APPLICATION

None.

### TECHNICAL FIELD

The present application relates to generative AI systems, methods, and apparatuses for managing compliance through advanced processes involving AI-driven aggregation, filtering, and classification of regulatory, operational, and industry-specific data. The present system provides comprehensive computing functionality for dynamically collecting compliance-related information, creating sub-industry-specific compliance tasks, managing task allocation and monitoring, and offering real-time AI assistance for compliance support. Additionally, the system ensures continuous optimization and adaptability to evolving standards and real-world incidents through AI-driven analysis and refinement. For example, the present application may be classified under G06Q10/06 for data processing systems or methods specifically adapted for administrative, commercial, or financial purposes, including task management; or G06Q50/00 for systems involving compliance monitoring and enforcement within specialized industries such as healthcare, construction, or finance.

### SUMMARY

Embodiments disclosed herein relate to methods and systems for creating and managing compliance protocols.

### BRIEF DESCRIPTION OF THE DRAWINGS

FIG. 1 is a system diagram illustrating a computer-implemented method for AI-driven compliance management, showcasing processes including data aggregation, automated filtering and classification, sub-industry-specific task generation, task management, real-time compliance assistance, and AI-powered task optimization, according to some embodiments of the present disclosure.

FIG. 2 illustrates a computer-implemented system for an AI-driven system that generates, assigns, and refines compliance tasks by leveraging AI-driven analysis to transform regulatory obligations into structured workflows.

### DETAILED DESCRIPTION

Managing compliance with legal, regulatory, and operational standards presents significant challenges for organizations across industries. The increasing complexity, volume, and dynamic nature of regulations, coupled with industry-specific requirements, place substantial burdens on businesses striving to maintain adherence. Traditional compliance management approaches relies heavily on manual processes, which are error-prone, resource-intensive, and unable to adapt swiftly to evolving regulatory landscapes.

Small and medium-sized enterprises face critical barriers due to limited resources and infrastructure for managing compliance. These constraints often lead to outdated compliance protocols, ineffective task distribution, and insufficient employee training, exposing organizations to financial penalties, reputational damage, and operational disruptions. Non-compliance can escalate to legal liabilities, lawsuits, and even business closures, highlighting the critical need for an effective and adaptive compliance management system.

Existing compliance solutions frequently lack personalization and fail to address the nuanced requirements of specific organizations, employees, and industries. generic protocols, combined with the absence of tailored workflows or role-specific task assignments based on real-time compliance monitoring, increase inefficiencies and risks of non-compliance. The lack of tools to support dynamic task allocation, real-time support, and task optimization further delays the detection and resolution of compliance gaps, increasing organizational vulnerability.

Therefore, it is an aim of the present disclosure to provide an AI-driven system designed to overcome the aforementioned limitations. In some embodiments, the system streamlines compliance management by integrating advanced technologies such as artificial intelligence (AI), machine learning (ML), and natural language processing (NLP). The system transforms compliance requirements into actionable, role-specific workflows offers real-time AI assistance for compliance clarification, and provides continuous optimization and monitoring tools. These capabilities enable businesses to adapt swiftly to regulatory changes, reduce administrative burdens, and mitigate non-compliance risks.

The present disclosure further introduces a comprehensive compliance management solution comprising a system built on modular components that work together to streamline compliance management. It includes Data Aggregation, which uses AI-driven Open Source Intelligence (OSINT) techniques to collect compliance-related data from regulatory, operational, and industry-specific sources and news outlets. The Data Processing module automates filtering and classification of the aggregated data, extracting actionable insights through AI. The Task Generation module creates sub-industry-specific compliance tasks tailored to organizational needs, while the Task Management module handles the allocation, monitoring, and reporting of these tasks using a centralized platform. To support employees, the system includes a Compliance Assistance module that provides real-time AI-driven guidance for compliance clarification and task execution. Finally, the Incident Conclusion and Task Optimization module continuously refines workflows and compliance processes through AI-driven analysis and insights, ensuring ongoing efficiency and adaptability.

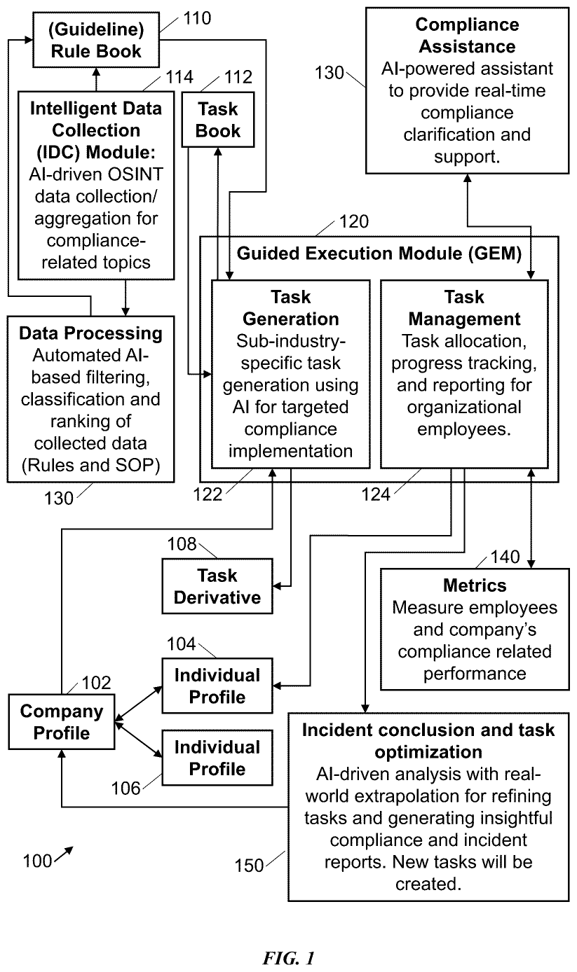

The present disclosure involves specialized AI-driven data aggregation, compliance-specific task processing, and real-time monitoring functionalities that when implemented represent a technical improvement to existing compliance management systems. Turning now to FIG. 1, the diagram illustrates an exemplary embodiment of a computer-implemented compliance management system designed to identify key compliance tasks specific to the unique circumstances of a regulated activity in a business, identify individuals responsible for regulated activities, generating and assigning tasks, and monitoring compliance and the effectiveness of the tasks assigned.

In some embodiments, the compliance management system leverages advanced AI-driven technologies to dynamically collect, filter, and process compliance-related data, generate actionable workflows, support employees with real-time assistance, and continuously refine task execution based on historical performance data and feedback. These capabilities address the evolving challenges of compliance management and ensure continuous adaptability to operational and regulatory environments. The compliance management system provides real-time compliance adaptation to regulatory changes and individual performance, Machine learning-based compliance refinement, and AI-driven risk forecasting and mitigation.
Intelligent Data Collection (IDC) Module: In some embodiments, the Intelligent Data Collection (IDC) Module of the compliance management system may begin by implementing an AI-driven Open-Source Intelligence (OSINT) process for gathering compliance-related data, often from diverse sources and sources that are unique to the regulated industry in which a compliance monitoring solution is sought. For example, these sources may include legal databases, regulatory websites, news websites, industry standards, government press releases, indictments, verdicts, and organizational Standard Operating Procedures (SOPs). Using advanced web-scraping techniques and dynamic crawling parameters guided by predefined prompts, the module ensures comprehensive data collection. For example, in the healthcare industry, the module may prioritize data on patient privacy laws such as HIPAA, while in the finance sector, it focuses on anti-money laundering (AML) regulations and data security frameworks like PCI-DSS. In some embodiments, the system may learn from previous compliance actions to refine future research.
Guided Execution Module (GEM)-In some embodiments, the Guided Execution Module (GEM) serves as the core processing engine for transforming raw compliance data into structured, actionable workflows. In some embodiments, the GEM is responsible for both data processing and task generation, ensuring that regulatory updates, industry standards, and organizational policies are intelligently analyzed and converted into compliance tasks. In some embodiments, the GEM module may govern two critical functions: the Data Processing Module, which applies AI-driven filtering, classification, and ranking techniques to extract relevant compliance insights, and the Task Generation Module, which structures those insights into sub-industry-specific workflows tailored to an organization's unique regulatory landscape.

In some embodiments, the Rule Book and Task Book may play a pivotal role in this transformation, while the Rule Book houses categorized compliance obligations, legal interpretations, and SOPs, the Task Book defines the corresponding actions, responsibilities, and role-based compliance tasks necessary to ensure compliance. Together, these components provide a comprehensive framework for dynamic compliance management, ensuring that organizations remain responsive to regulatory changes. As the GEM processes compliance data, it refines task assignments and prioritization based on industry relevance, historical adherence trends, and organizational risk factors.

In some embodiments, the operations of the Guided Execution Module (GEM) are facilitated by modules. In some embodiments, a Task Generation Module facilitates operations like identifying web-based compliance-related data using a web scraping module guided at least in part by a scraping prompt. In some embodiments, the Task Generation Module may also extract base data from the compliance-related data. In some embodiments, the processed data is transformed into sub-industry-specific compliance tasks using AI-powered algorithms. The Task Generation module ensures that tasks are tailored to address the unique operational and regulatory needs of a specific organization. For example, in the construction industry, the module could generate workflows for compliance with Occupational Safety and Health Administration (OSHA) standards, such as equipment inspections, hazard training, and adherence to regional building codes. Similarly, in the technology sector, tasks may include compliance with intellectual property laws, software licensing audits, and data protection regulations like GDPR.

In some embodiments, the operations of the Guided Execution Module (GEM) are facilitated by a Task Management Module. In some embodiments, the task management module allocates compliance tasks to employees based on their roles, responsibilities, and organizational hierarchies. The Task Management Module includes routines, APIs for tracking task progress, generating detailed compliance performance reports, and capabilities for issuing reminders for overdue or incomplete tasks. For example, legal teams may receive tasks related to contract reviews, while IT teams are tasked with updating security protocols. The Task Management Module may also integrate seamlessly with organizational systems like ERP or CRM tools to track compliance adherence and update task status in real-time.
Data Processing Module: Once data is aggregated, in some embodiments, the Data Processing Module applies AI-based filtering, classification, and ranking techniques to ensure only actionable and relevant compliance information is passed to downstream components. In some embodiments, the GEM module employs natural language processing (NLP) to interpret unstructured data and categorize it into compliance rules, tasks, and priorities. For examplary, regulatory updates about environmental impact assessments could be identified, ranked, and prioritized for integration into workflows. Feedback loops within the system dynamically refine these filters, improving accuracy over time.
Compliance Assistance Module: To support employees during task execution, the system includes an AI-powered assistant that provides real-time clarification of compliance-related queries and guidance on task completion. This module reduces ambiguity and improves adherence by offering instant access to relevant regulations, SOPs, and actionable instructions. For instance, employees can use the assistant to clarify steps for submitting regulatory reports or updating operational procedures following a new standard.
Task Optimization Module: Using advanced AI-driven analytics, this module evaluates task completion data, adherence metrics, and compliance risks to refine workflows and generate insightful compliance and incident reports. By analyzing historical performance and real-world outcomes, the module ensures continuous improvement. For example, if recurring compliance violations are detected in a particular department, the system adjusts task sequencing and provides targeted training recommendations. In industries like finance, this module could also identify patterns of risk in anti-money laundering protocols and propose additional safeguards.
Metrics Module: Embedded within the system, this module measures both employee and organizational compliance performance. Key performance indicators, such as task completion rates, adherence levels, and time-to-compliance, are tracked and visualized through interactive dashboards. This module integrates predictive analytics to identify potential compliance risks and support proactive mitigation strategies. For example, management can monitor trends indicating delays in regulatory reporting and implement corrective actions.
Incident Conclusion and Workflow Refinement: After task execution, the system performs AI-driven extrapolation of outcomes to refine future workflows and generate new compliance tasks. For instance, following the resolution of a regulatory incident, the system updates task libraries, incorporates lessons learned, and dynamically adjusts workflows to prevent recurrence.

The modular architecture of the system enables flexibility, scalability, and industry-specific customization, ensuring that workflows are optimized for diverse organizational needs. By automating compliance processes, providing real-time assistance, and continuously refining workflows, the system mitigates risks, reduces administrative burdens, and improves adherence across industries.

FIG. 1 illustrates an exemplary system 100 of an AI-driven compliance management system that transforms regulatory and organizational guidelines into structured compliance workflows. System 100 may process compliance-related data using AI-driven automation and generate tailored compliance tasks for individuals 104, 106 within an organization, at least some of the attributes of the organization are captured within the Company Profile 102. In some embodiments, the system 100 may further refine compliance workflows using feedback loops and performance metrics 140 to ensure continuous improvement in the creation of tasks, refinements to the Rule Book 110, the Task Book 112, and Task Derivatives 108. The structure of system 100 enables compliance-related processes to remain dynamic, adaptable, capable of evolving in response to new regulatory requirements, and responsive to the effectiveness of the task derivative 108 as determined by the compliance metrics 140.

In some embodiments, system 100 may include regulatory data, industry guidelines, and internal policies stored in Rule Book 110, and organizational data, including personnel and operational structures, from Company Profile 102 and Individual Profiles 104, 106. In some embodiments, the system 100 may output task assignments and compliance workflows stored in Task Book 112, AI-generated compliance workflows and real-time guidance from the Guided Execution Module (GEM) 120, compliance performance metrics from Metrics Module 140, and adaptive compliance recommendations from Incident Conclusion and Task Optimization Module 150.

In some embodiments, the Rule Book 110 may serve as a repository for compliance-related information, including regulatory frameworks, industry guidelines, and internal standard operating procedures (SOPs). The Rule Book 110 may ensure that compliance tasks and workflows generated within system 100 are derived from authoritative sources. In some embodiments, the Rule Book 110 may provide a structured database of compliance obligations and best practices, serving as a reference for downstream modules of system 100. The Rule Book 110 may store and organize compliance policies, statutory requirements, and judicial decisions, ensuring that regulatory mandates remain accessible for compliance management operations.

In some embodiments, system 100 may employ natural language processing (NLP) and machine learning algorithms to classify and structure compliance data stored within the Rule Book 110. The Rule Book 110 may categorize compliance obligations based on relevance, industry application, and regulatory priority, ensuring that compliance-related content remains actionable for downstream processing. In some embodiments, system 100 may extract legal principles, policy mandates, and jurisdiction-specific enforcement trends from the Rule Book 110, converting these elements into structured compliance schemas for further analysis and implementation.

In some embodiments, the Rule Book 110 may interact with the Guided Execution Module (GEM) 120 to facilitate compliance rule interpretation and task generation. The Guided Execution Module 120 may reference compliance obligations stored in the Rule Book 110 to determine applicable compliance requirements for an organization and generate corresponding workflows. In some embodiments, the Task Book 112 may store compliance tasks derived from the Rule Book 110, ensuring that compliance-related actions align with regulatory mandates and organizational policies.

In some embodiments, the Rule Book 110 may be refined using feedback mechanisms within the Incident Conclusion and Task Optimization Module 150. The Incident Conclusion and Task Optimization Module 150 may analyze compliance enforcement data, regulatory trends, and historical compliance incidents to dynamically adjust rule interpretations stored in the Rule Book 110. In some embodiments, system 100 may modify compliance obligations within the Rule Book 110 in response to evolving case law, regulatory changes, and industry-specific compliance trends.

For example, in some embodiments, system 100 may identify a judicial decision that imposes expanded liability on corporate executives for compliance failures. The Rule Book 110 may incorporate the judicial ruling and update compliance obligations accordingly. The Guided Execution Module 120 may analyze the updated requirements and generate additional compliance training tasks for relevant personnel. The Task Book 112 may store these training requirements as mandatory compliance actions, and the Metrics Module 140 may track adherence to ensure implementation. If compliance adherence trends indicate gaps in employee training, the Incident Conclusion and Task Optimization Module 150 may further refine the compliance framework within the Rule Book 110, ensuring that system-wide compliance measures remain aligned with regulatory enforcement practices.

In some embodiments, the Rule Book 110 may support adaptive compliance management by maintaining an authoritative source of compliance obligations while enabling system 100 to dynamically refine, update, and apply compliance policies based on real-time legal and industry developments.

In some embodiments, Intelligent Data Collection (IDC) Module 114 may aggregate compliance-related data from diverse sources using AI-driven Open Source Intelligence (OSINT) techniques. IDC Module 114 may identify, extract, and structure relevant compliance information before transmitting compliance information to Data Processing Module 122.

In some embodiments, Data Processing Module 122 may apply AI-based filtering, classification, and ranking techniques to ensure that system 100 processes only actionable and relevant compliance information. Data Processing Module 122 may employ Natural Language Processing (NLP) techniques to convert unstructured data into structured compliance rules. In some embodiments, Data Processing Module 122 may categorize compliance rules, tasks, and priorities dynamically using machine learning models trained on regulatory updates.

In some embodiments, Guided Execution Module (GEM) 120 may serve as a central execution engine within system 100. GEM 120 may ingest processed compliance data from Data Processing Module 122 and convert processed compliance data into structured compliance tasks.

In some embodiments, the Guided Execution Module (GEM) 120 may include the Task Generation Module 122 and the Task Management Module 124, which operate to turn actionable compliance data into structured, executable tasks. The Task Generation Module 122 may employ AI-driven algorithms to generate compliance tasks tailored to specific industries, ensuring alignment with regulatory frameworks, operational policies, and organizational hierarchies. The Task Management Module 124 may facilitate the allocation, tracking, and execution of these compliance tasks, integrating seamlessly with enterprise resource planning (ERP) and customer relationship management (CRM) systems.

In some embodiments, the Task Generation Module 122 may receive processed data from Data Processing Module 120, extracting compliance-relevant obligations and structuring them into actionable workflows. For example, if the Intelligent Data Collection (IDC) Module identifies new regulatory changes regarding financial reporting compliance, the Task Generation Module 122 may create corresponding workflows, such as periodic audit requirements and automated financial disclosure submissions. Additionally, the Task Generation Module 122 may establish dependencies between multiple compliance tasks, ensuring sequenced execution based on regulatory priority levels. For instance, if a jury verdict establishes a precedent regarding workplace safety violations, the Task Generation Module 122 may create a task hierarchy, requiring legal review of the new ruling before updating internal safety policies

In some embodiments, the Task Management Module 124 may dynamically assign compliance tasks to employees based on role-based access controls, expertise levels, and organizational workflow structures. The Task Management Module 124 may also incorporate real-time tracking mechanisms, enabling supervisors to monitor task completion progress, compliance adherence levels, and performance metrics. If a compliance task remains incomplete beyond a predetermined threshold, the Task Management Module 124 may escalate the task, triggering reminders or supervisory intervention.

In some embodiments, Task Book 112 may store compliance workflows generated by GEM 120 and serve as a reference for assigned compliance tasks. In some embodiments, Task Book 112 may provide a structured repository of assigned compliance tasks, including deadlines, dependencies, and priority levels.

In some embodiments, Task Derivative 108 may refine compliance workflows based on organizational structures and individual roles to ensure tailored compliance task assignments.

In some embodiments, the Compliance Assistance Module 130 may provide real-time AI-driven guidance to employees executing compliance tasks, ensuring clarity in regulatory requirements and enhancing task adherence. The Compliance Assistance Module 130 may function as an interactive AI interface, allowing employees to receive instant explanations of compliance obligations, verify procedural steps, and obtain automated recommendations for completing assigned compliance tasks

In some embodiments, the Metrics Module 140 may evaluate compliance performance at both employee and organizational levels. The Metrics Module 140 may track task completion rates, adherence levels, and compliance risks, providing real-time analytics and dashboards that enable organizations to monitor regulatory compliance across various departments. In some embodiments, the Metrics Module 140 may analyze historical compliance data, tracking patterns of adherence and non-compliance to generate insights that support proactive risk mitigation strategies. The Metrics Module 140 may compare individual employee compliance behaviors with organizational benchmarks to detect anomalies or trends that could indicate emerging risks.

In some embodiments, the Metrics Module 140 may use predictive analytics to identify compliance risks before violations occur. The Metrics Module 140 may assess the frequency and severity of past compliance failures to determine the likelihood of future regulatory infractions. In some embodiments, system 100 may utilize the Metrics Module 140 to establish compliance performance thresholds, wherein deviations from expected compliance behavior may trigger automated alerts or additional compliance training requirements. The Metrics Module 140 may integrate with the Incident Conclusion and Task Optimization Module 150 to refine compliance workflows based on identified risks, ensuring that organizations adjust compliance strategies dynamically in response to emerging threats.

In some embodiments, the Metrics Module 140 may incorporate real-time compliance tracking by continuously monitoring employee interactions with assigned compliance tasks in the Task Book 112. The Metrics Module 140 may assess whether compliance-related actions are completed within required timeframes and whether assigned personnel engage with compliance protocols in a manner consistent with best practices. If employees demonstrate repeated failures to adhere to compliance policies, the Metrics Module 140 may initiate recommendations for additional compliance training or intervention strategies.

For example, in some embodiments, if the Metrics Module 140 detects that employees within a specific department consistently fail to complete mandatory compliance training on time, system 100 may adjust compliance task assignments to prioritize high-risk areas. The Metrics Module 140 may further analyze whether compliance lapses correlate with broader organizational trends, such as workforce turnover, shifting regulatory requirements, or gaps in compliance training programs. The Metrics Module 140 may generate visualized compliance reports, enabling organizational leadership to assess risk exposure and allocate resources effectively to mitigate compliance vulnerabilities.

In some embodiments, the Metrics Module 140 may interface with external regulatory reporting systems, enabling system 100 to generate automated compliance audit reports based on real-time adherence data. If an organization is subject to regulatory inspections, the Metrics Module 140 may provide regulators with structured evidence of compliance efforts, reducing the likelihood of penalties or enforcement actions. In some embodiments, the Metrics Module 140 may contribute to long-term compliance optimization by analyzing trends across multiple organizations, allowing system 100 to benchmark compliance effectiveness against industry-wide best practices.

In some embodiments, the Metrics Module 140 may function as a central analytical engine for system 100, ensuring that compliance performance is continuously assessed, refined, and aligned with evolving regulatory and industry standards.

In some embodiments, the Incident Conclusion and Task Optimization Module 150 may analyze real-world compliance incidents and dynamically refine compliance workflows to enhance regulatory adherence. The Incident Conclusion and Task Optimization Module 150 may assess historical compliance data, industry-specific enforcement actions, and internal organizational performance metrics to adjust compliance procedures in response to evolving regulatory requirements. The Incident Conclusion and Task Optimization Module 150 may ensure that compliance workflows remain adaptive by integrating feedback loops that continuously improve compliance task sequencing and execution.

In some embodiments, the Incident Conclusion and Task Optimization Module 150 may leverage machine learning models to evaluate task completion trends and compliance infractions, identifying systemic weaknesses in organizational compliance programs. The Incident Conclusion and Task Optimization Module 150 may utilize pattern recognition techniques to detect anomalies in adherence rates and generate predictive insights regarding potential compliance risks. For example, if multiple employees fail to complete a mandatory compliance task within a designated timeframe, the Incident Conclusion and Task Optimization Module 150 may adjust task assignments, introduce additional training modules, or restructure task dependencies to ensure improved completion rates.

In some embodiments, the Incident Conclusion and Task Optimization Module 150 may operate in coordination with the Metrics Module 140, enabling system 100 to analyze the impact of compliance interventions over time. The Incident Conclusion and Task Optimization Module 150 may dynamically modify compliance workflows based on real-world incidents, regulatory updates, or newly established legal precedents. For instance, if a court ruling redefines the interpretation of an existing compliance obligation, the Incident Conclusion and Task Optimization Module 150 may update the Rule Book 110, generate new compliance schemas, and instruct the Task Book 112 to distribute revised compliance actions to relevant personnel.

In some embodiments, the Incident Conclusion and Task Optimization Module 150 may assess whether compliance protocol updates necessitate adjustments to compliance reporting mechanisms. The Incident Conclusion and Task Optimization Module 150 may determine whether new compliance rules require additional documentation, policy revisions, or modifications to external regulatory filings. If a company operating in a regulated industry receives a government-issued compliance mandate, the Incident Conclusion and Task Optimization Module 150 may ensure that all affected employees receive updated compliance instructions, and the completion of compliance actions is properly documented within system 100.

For example, in some embodiments, if the Incident Conclusion and Task Optimization Module 150 identifies a recurring compliance violation in a particular department, system 100 may modify task structures to introduce additional oversight mechanisms. The Incident Conclusion and Task Optimization Module 150 may escalate certain compliance tasks to managerial review or require additional verification steps before task completion is confirmed. In some embodiments, system 100 may deploy reinforcement learning techniques to iteratively improve compliance strategies, ensuring that regulatory adherence measures evolve in response to real-world operational conditions.

In some embodiments, the Incident Conclusion and Task Optimization Module 150 may function as a central compliance refinement engine within system 100, continuously optimizing compliance workflows, adapting compliance procedures to regulatory shifts, and ensuring that compliance management strategies remain aligned with industry best practices.

FIG. 1 presents system 100, a structured AI-driven compliance framework that may dynamically process compliance data, generate tailored workflows, and continuously improve regulatory adherence through AI-powered optimization. System 100 may ensure that compliance tasks are industry-specific, role-based, and continuously refined using real-world data and feedback loops.

Through these interconnected modules, as depicted in FIG. 1, the system dynamically adapts to changing compliance landscapes, ensuring organizations remain aligned with legal, regulatory, and operational requirements. The AI-driven approach enhances efficiency, precision, and accountability, making this system an essential tool for modern compliance management.

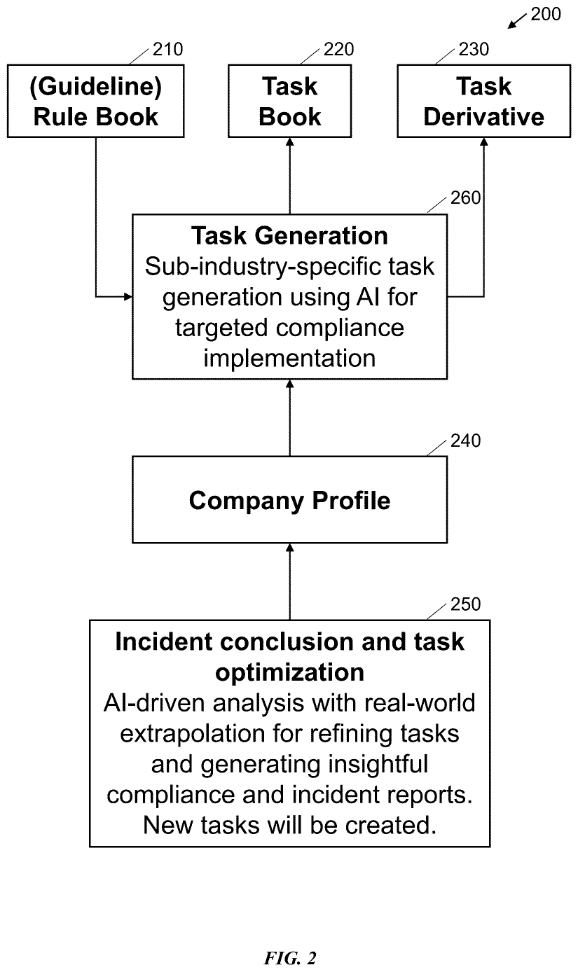

FIG. 2 illustrates an AI-driven compliance task generation and refinement process within system 200, which may structure compliance workflows using adaptive AI-driven analysis. In some embodiments, system 200 may generate compliance tasks based on regulatory data stored in the Rule Book 210, assign and refine tasks within the Task Book 220, and further adapt compliance workflows using insights from the Task Derivative 230. The Task Generation Module 260 may integrate organizational compliance requirements from the Company Profile 240, while the Incident Conclusion and Task Optimization Module 250 may ensure continuous refinement of compliance workflows based on real-world regulatory events and organizational performance data.

In some embodiments, system 200 may ingest compliance obligations from regulatory frameworks, industry guidelines, and internal standard operating procedures (SOPs) stored in the Rule Book 210. The Rule Book 210 may function as a structured repository, ensuring that compliance workflows remain aligned with authoritative sources. The Task Book 220 may store generated compliance tasks, providing structured compliance workflows that align with industry and organizational needs. In some embodiments, the Task Derivative 230 may function as an adaptive layer, refining compliance workflows based on organizational structures, employee roles, and historical compliance performance.

In some embodiments, the Task Generation Module 260 may receive compliance obligations from the Rule Book 210 and generate industry-specific compliance tasks. The Task Generation Module 260 may employ AI-driven logic to structure compliance tasks according to regulatory mandates and operational requirements. For example, in some embodiments, if a new financial reporting mandate is detected in the Rule Book 210, the Task Generation Module 260 may create compliance workflows ensuring that finance personnel receive updated reporting guidelines. The Task Generation Module 260 may also establish task dependencies, ensuring that prerequisite compliance actions are completed before subsequent tasks are assigned.

In some embodiments, the Company Profile 240 may store organization-specific compliance data, including corporate governance structures, employee compliance histories, and operational risk assessments. The Company Profile 240 may inform task generation by ensuring that compliance workflows align with an organization's regulatory exposure and operational scope. If an organization operates in multiple jurisdictions, the Company Profile 240 may provide jurisdiction-specific compliance requirements, enabling the Task Generation Module 260 to generate regionally tailored compliance workflows.

In some embodiments, the Incident Conclusion and Task Optimization Module 250 may analyze real-world compliance incidents and refine compliance workflows dynamically. The Incident Conclusion and Task Optimization Module 250 may assess regulatory enforcement actions, legal precedents, and organizational compliance performance to continuously adapt compliance task structures. For example, if a regulatory body issues a new enforcement directive related to data privacy violations, the Incident Conclusion and Task Optimization Module 250 may modify the Task Book 220, introducing additional training requirements or refining compliance reporting mechanisms.

In some embodiments, the Incident Conclusion and Task Optimization Module 250 may function as a feedback loop within system 200, ensuring that compliance workflows remain responsive to evolving regulatory landscapes. The Incident Conclusion and Task Optimization Module 250 may update compliance task structures based on real-world compliance trends, integrating machine learning techniques to predict compliance risks and proactively adjust workflows. If certain compliance tasks demonstrate low completion rates, the Incident Conclusion and Task Optimization Module 250 may introduce workflow modifications, including automated task reassignment, enhanced compliance training, or additional review mechanisms.

FIG. 2 presents system 200 as an AI-driven compliance framework that dynamically structures, monitors, and refines compliance workflows. The Task Generation Module 260 may ensure that compliance obligations are translated into structured tasks, while the Incident Conclusion and Task Optimization Module 250 may ensure that compliance workflows evolve based on regulatory enforcement patterns and organizational compliance performance.

The foregoing disclosure provides illustration and enabling description but is not intended to be exhaustive or to limit the implementations or claims to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limited to the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented system for generating and managing compliance protocols, the system comprising:
a. at least one processor;
b. at least one non-transitory computer-readable storage medium comprising instructions that, when executed by the at least one processor, cause the system to perform operations comprising:
i. executing an Intelligent Data Collection (IDC) Module for aggregating web-based compliance-related data into a compliance schema, wherein the web-based compliance-related data includes at least an organizational record and base data from one or more of a legal source, a regulatory source, and an industry standards source, wherein the aggregating comprises:
1. identifying web-based compliance-related data using a web scraping module guided at least in part by a scraping prompt; and
2. extracting base data from the compliance-related data; and
ii. executing a Guided Execution Module (GEM) Engine for processing the compliance schema, wherein the processing comprises:
1. prioritizing at least a portion of the base data as actionable data;
2. interpreting at least a portion of the actionable data as two or more compliance tasks;
3. identifying at least one dependency between the two or more compliance tasks; and
4. sequencing the two or more compliance tasks into the compliance schema.

2. The computer-implemented system of claim 1, wherein the instructions for executing the Intelligent Data Collection (IDC) Module further configure the at least one processor to apply a machine learning module to the aggregating, wherein applying the machine learning module comprises:
i. analyzing historical compliance adherence metrics and user input to assess the relevance of the base data within the compliance-related data; and
ii. dynamically adjusting the scraping prompt; and
iii. testing an impact of the scraping prompt on the compliance protocol.

3. The computer-implemented system of claim 2, wherein the instructions for executing the Intelligent Data Collection (IDC) Module further configure the at least one processor to incorporate a feedback mechanism, wherein the feedback mechanism:
a. receives inputs from subsequent compliance processing modules, including reports or compliance adherence metrics;
b. adjusts the operation of the web scraping module or NLP module based on identified gaps, redundancies, or inaccuracies in previously aggregated data; and
c. updates the compliance schema to reflect the refined data and adjusted operations.

4. The computer-implemented system of claim 3, wherein the instructions for executing the web scraping module further configure the at least one processor to periodically scan an internet source to identify text from one or more of the legal source, the regulatory source, and the industry standards source for inclusion in the compliance schema; and transferring the compliance schema to the Guided Execution Module (GEM) Engine.

5. The computer-implemented system of claim 4, wherein executing a Guided Execution Module (GEM) Engine for processing the compliance schema, wherein the processing further comprises:
a. receiving the transferred base data;
b. updating at least one compliance task based at least in part on the transferred base data; and
c. updating the compliance protocol with the at least one updated compliance task.

6. The computer-implemented system of claim 4, wherein executing a Guided Execution Module (GEM) Engine for processing the compliance schema, wherein the processing further comprises:
a. interpreting the base data into one or more compliance rules;
b. associating the one or more compliance rules with a compliance outcome; and
c. training a machine learning model to improve compliance task prioritization and compliance schema accuracy using the one or more compliance rules with a respective compliance outcome.

7. The computer-implemented system of claim 1, wherein executing a Guided Execution Module (GEM) Engine for processing the compliance schema, wherein the processing further comprises:
a. sequencing the two or more compliance tasks into one or more structured workflows based at least in part on the identified at least one dependency between the two or more compliance tasks; and
b. dynamically author one or more workflows for the compliance protocol based at least in part on one or more of a rule-based algorithm and an AI-enhanced algorithm.

8. The computer-implemented system of claim 1, wherein executing a Guided Execution Module (GEM) Engine for processing the compliance schema, wherein the processing further comprises:
a. receiving the base data at the GEM Engine if the changes to the two or more compliance tasks exceed a threshold; or
b. saving in memory the identified base data changes to the two or more compliance tasks if the changes to the two or more compliance tasks do not exceed the threshold.

9. The computer-implemented system of claim 1, further comprising instructions for a Personalized Task Distribution System that, when executed by the at least one processor, cause the Personalized Task Distribution System to perform operations comprising creating one or more role-dependent structured workflows based at least in part on the organizational record and at least one industry requirement.

10. The computer-implemented system of claim 9, further comprising instructions that, when executed by the at least one processor, cause the Personalized Task Distribution System to perform operations comprising:
a. converting the one or more role-dependent structured workflows into at least one of a role-specific structured workflow or a structured workflow task list; and
b. delivering the role-specific structured workflow or the structured workflow task list to at least one employee; and
c. updating at least one employee record to reflect delivery of the role-specific structured workflow or the structured workflow task list to the at least one employee.

11. The computer-implemented system of claim 9, further comprising instructions that, when executed by the at least one processor, cause the Personalized Task Distribution System to perform operations comprising:
a. wherein the role-specific structured workflow and the structured workflow task list comprise:
at least one employee compliance application, wherein the employee compliance application displays at least one of the role-specific structured workflow or the structured workflow task list.

12. The computer-implemented system of claim 9, further comprising instructions for a Modular Education, Reporting, and Evaluation System that, when executed by the at least one processor, cause the Modular Education, Reporting, and Evaluation System to perform operations comprising:
a. administering a role-specific training program to an employee based at least in part on the compliance protocol;
b. tracking training progress of the role-specific training program relative to the employee;
c. monitoring task adherence of the employee; and
d. generating compliance performance data based at least in part on the tracked training progress and the monitored task adherence.

13. The computer-implemented system of claim 8, further comprising instructions for an Automated Standards Management and Monitoring System that, when executed by the at least one processor, causes the Automated Standards Management and Monitoring System to perform operations comprising:
a. monitoring regulatory and operational standards for a change above a threshold;
b. integrating updated regulatory and operational standards into an organizational workflow in real time if the threshold is exceeded; and
c. storing an updated compliance protocol in memory.

14. The computer-implemented system of claim 12, wherein the Automated Standards Management and Monitoring System further comprises a Reporting Tool that, when executed by the at least one processor, causes the Reporting Tool to perform operations comprising:
a. aggregating compliance performance data based at least in part on the tracked training progress and the monitored task adherence;
b. applying predictive analytics to the aggregated compliance performance data based at least in part on the tracked training progress and the monitored task adherence to identify at least one potential compliance risk; and
c. displaying the at least one potential compliance risk in a user interface.
